(19) United States
(12) Patent Application Publication
(10) Pub. No.: US 2007/0294138 A1
(43) Pub. Date: Dec. 20, 2007

(54) Sheet processing system, sheet processing method, program, and optically read sheet

(76) Inventor: Kazuaki Yokota, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/808,146

(22) Filed: Jun. 7, 2007

(30) Foreign Application Priority Data
Jun. 8, 2006 (JP) P2006-160271

(51) Int. Cl. G06Q 30/00

(52) U.S. Cl. 705/26

(57) ABSTRACT

Predetermined spaces at different positions in a whole space possible to be given position information by dot patterns are allotted to a plurality of entry boxes provided in a sheet, and definition information for each sheet is associated in advance with the relation between the plural entry boxes and the spaces allotted thereto. At the time of the entry in the sheet, a pen device reads the dot pattern at the entry position and decodes the position information to output the position information to a host device. The host device determines a customer code corresponding to an arrangement of space numbers by using a series of the position information acquired from the pen device and a space number determination table.

### CROSS-REFERENCE TO RELATED APPLICATIONS

This application is based upon and claims the benefit of priority from the prior Japanese Patent Application No. 2006-160271, filed on Jun. 8, 2006; the entire contents of which are incorporated herein by reference.

### BACKGROUND

1. Field of the Invention

The present invention relates to a sheet processing system which processes an output of a pen device having functions of writing in a sheet on which a plurality of marks representing position information are printed and at the same time reading the marks at an entry position to decode the position information, a sheet processing method, a program, and an optically read sheet.

2. Description of the Related Art

There is an art in which a value of a mark is expressed by a position of the mark relative to a reference point, a plurality of the marks are vertically and laterally arranged to form a pattern as one recognition object, and these patterns of the marks are printed on an optically read sheet (for example, Patent Reference 1 and so on).

One concrete application is a method in which a pattern made up of 6×6 dots vertically and laterally arranged at an average of 0.3 mm intervals is defined as one piece of position information and such position information is given to a two-dimensional space.

In this method, the dots are set at positions slightly deviated in four upward, downward, leftward, and rightward directions from the respective reference positions set at 0.3 mm intervals, and a value of each of the dots is expressed by the position of the dot relative to the reference position.

This method can generate different patterns in number equal to 4 raised to the 36th power by combining the values of the vertical and lateral 6×6 dots, which makes it possible to give the position information to a vast two dimensional space.

If dot pattern groups corresponding to different partial spaces in such a vast two dimensional space are printed on a front face of a sheet, by reading the dot patterns existing at entry positions by a camera mounted in the pen device and decoding the read dot patterns when a character is written in the sheet by the pen device, it is possible to obtain a series of position information corresponding to strokes of the pen device, so that the character can be recognized based on the series of the position information.

Incidentally, in a system using a computer to process a sheet, it is a general practice to manage customers by using code numbers assigned to the respective customers.

In such management, to identify a customer, a result obtained by character recognition of the customer name entered in a sheet is collated with customer names stored in correspondence to the customer codes.

However, in such a system, a customer has to write both his/her own name (customer name) and customer code on the sheet.

Therefore, each customer has to keep his/her customer code by himself/herself, which is a burden to the customer.

On the other hand, in a method of scanning the whole front face of a sheet by a line scanner or the like to read information from the sheet, if a customer code itself or a barcode or the like which is a coded customer code is printed on the sheet, it is possible to read the customer code when the front face of the sheet is scanned.

However, in the above-described method of reading the position information from the dot pattern, only stroke portions of the pen are scanned, which poses a problem that the customer code, the barcode, or the like printed on the sheet cannot be read.

As a method for identifying a customer as described above, there has been proposed a method in which different partial spaces in a whole space possible to be given position information by the dot pattern are allotted to respective customer codes, the dot pattern corresponding to the space is printed on a sheet, and a camera installed in a pen device photographs the dot pattern, whereby the customer code is read (for example, Patent Reference 2 and so on).

[Patent Reference 1] JP-A 2003-511761 (KOHYO)

[Patent Reference 2] JP-A 2005-215815 (KOKAI)

### SUMMARY

However, the method of allotting a unique space to each customer code requires dot patterns in number corresponding to the space having an area proportional to the number of customers.

Although a space possible to be given the position information by the dot pattern is vast, inefficient consumption of the space may cause a problem of exhaustion of the dot patterns in the worst case.

In view of the above circumstances, it is an object of the present invention to provide a sheet processing system, a sheet processing method, a program, and an optically read sheet capable of realizing improved use efficiency of patterns such as, for example, dot patterns printed on a sheet, each giving information on a position of a space by positions of a plurality of marks relative to respective reference positions.

A sheet processing system according to one embodiment of the present invention is a sheet processing system including: an acquiring part acquiring an output of a pen device used for writing on a sheet on which marks arranged in each of a plurality of demarcated areas according to a predetermined arrangement rule are printed and whose entry position is specifiable by a combination of the marks, and reading values of the plural marks existing at each of entry positions to generate a series of position information; a first storage part storing identification information of the individual spaces allottable to the plural areas of the sheet and information on positions of the spaces in correspondence to each other; a first determining part which sequentially determines the identification information of the spaces allotted to the plural areas written on by the pen device, by comparing the series of the position information acquired by said acquiring part and the information on the positions of the individual spaces stored in said first storage part, and generates an arrangement of the identification information of the spaces; a second storage part storing in advance arrangements of the identification information of the spaces and information corresponding to the arrangements; and a second determining part which determines the information corresponding to the arrangement of the identification information of the spaces which is found to match the arrangement of the identification information of the spaces generated by said first determining part, as a result of comparing the generated arrangement of the identification information of the spaces and the arrangements of the identification information of the spaces stored in said second storage part.

A sheet processing method according to one embodiment of the present invention is a sheet processing method for processing a sheet on which marks arranged in each of a plurality of demarcated areas according to a predetermined arrangement rule are printed and whose entry position is specifiable by a combination of the marks, the method comprising: preparing a first storage part storing identification information of the individual spaces allottable to the plural areas of the sheet and information on positions of the spaces in correspondence to each other, and a second storage part storing in advance arrangements of the identification information of the spaces and information corresponding to the arrangements; acquiring an output of a pen device used for writing on the sheet and reading the values of the plural marks existing at each of entry positions to generate a series of the position information; sequentially determining the identification information of the spaces allotted to the plural areas written on by the pen device, by comparing the acquired series of the position information and the information on the positions of the individual spaces stored in the first storage part, and generating an arrangement of the identification information of the spaces; and determining the information corresponding to the arrangement of the identification information of the spaces which is found to match the generated arrangement of the identification information of the spaces, as a result of comparing the generated arrangement of the identification information of the spaces and the arrangements of the identification information of the spaces stored in the second storage part.

A program according to one embodiment of the present invention is a program realizing in a computer a function of processing a sheet on which marks arranged in each of a plurality of demarcated areas according to a predetermined arrangement rule are printed and whose entry position is specifiable by a combination of the marks, the program causing the computer to function as: an acquiring part acquiring an output of a pen device used for writing on the sheet and reading the values of the plural marks existing at each of entry positions to generate a series of the position information; a first storage part storing identification information of the individual spaces allottable to the plural areas of the sheet and information on positions of the spaces in correspondence to each other; a first determining part which sequentially determines the identification information of the spaces allotted to the plural areas written on by the pen device, by comparing the series of the position information acquired by said acquiring part and the information on the positions of the individual spaces stored in said first storage part, and generates an arrangement of the identification information of the spaces; a second storage part storing in advance arrangements of the identification information of the spaces and information corresponding to the arrangements; and a second determining part which determines the information corresponding to the arrangement of the identification information of the spaces which is found to match the arrangement of the identification information of the spaces generated by said first determining part, as a result of comparing the generated arrangement of the identification information of the spaces and the arrangements of the identification information of the spaces stored in said second storage part.

Therefore, it is possible to improve use efficiency of patterns such as, for example, dot patterns printed on a sheet, each giving information on a position of a space by positions of a plurality of marks relative to respective reference positions.

### BRIEF DESCRIPTION OF THE DRAWINGS

FIG. 1 is a view showing an example of a format of a sheet processed by a sheet processing system according to a first embodiment of the present invention.

FIG. 2 is a block diagram showing the whole configuration of the sheet processing system of the first embodiment.

FIG. 3 is a view showing the structure of a pen device used in the sheet processing system of the first embodiment.

FIG. 4 is a view showing an example of a space number determination table used in the sheet processing system of the first embodiment.

FIG. 5 is a view showing an example of a customer code determination table used in the sheet processing system of the first embodiment.

FIG. 6 is a flowchart showing the operation from the output of the pen device to the determination of a customer code in the sheet processing system of the first embodiment.

FIG. 7 is a view showing a format of a typical test answer sheet.

FIG. 8 is a view showing an example of a format of a sheet adopted in a sheet processing system of a second embodiment of the present invention.

FIG. 9 is a block diagram showing the whole configuration of the sheet processing system of the second embodiment.

FIG. 10 is a view showing an example of a space number determination table used in the sheet processing system of the second embodiment.

FIG. 11 is a view showing an example of a student number determination table used in the sheet processing system of the second embodiment.

FIG. 12 is a flowchart showing the operation from the output of a pen device to the determination of a student number in the sheet processing system of the second embodiment.

FIG. 13 is a view showing an example of a format of a sheet adopted in a sheet processing system of a third embodiment of the present invention.

FIG. 14 is a block diagram showing the whole configuration of the sheet processing system of the third embodiment.

FIG. 15 is a flowchart showing the operation from the output of a pen device and the determination of a customer code in the sheet processing system of the third embodiment.

FIG. 16 is a view showing an example of a dot pattern used in a sheet of the present invention.

### DETAILED DESCRIPTION

Hereinafter, embodiments of the present invention will be described based on the drawings.

Though the embodiments of the present invention will be described with reference to the drawings, these drawings are provided only for an illustrative purpose and in no way are intended to limit the present invention.

### First Embodiment

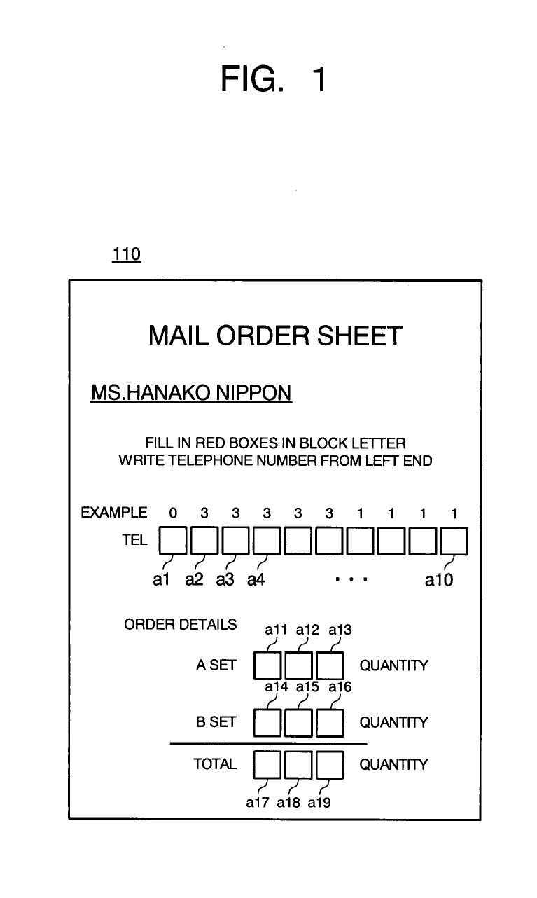

FIG. 1 is a view showing an example of a format of a sheet 110 processed by a sheet processing system according to a first embodiment of the present invention.

The sheet 110 is a mail order sheet. In the sheet 110, 10 entry boxes a1-a10 each for the entry of one character of a telephone number consisting of a ten-figure number and entry boxes a11-a19 for the entry of a purchase quantity of each kind of item.

In at least each of areas surrounded by the entry boxes a1-a19, 6×6 dots D1, . . . , D36 vertically and laterally arranged at an average of 0.3 mm intervals are provided and values of the respective dots D1, . . . , D36 are expressed by positions thereof relative to corresponding reference positions Bi, . . . , B36. The dots D1, . . . , D36 are marks.

The combination of the values of the dots D1, . . . , D36 is defined as one piece of position information, and different partial spaces in a whole space possible to be given the position information are allotted, and all the dot patterns corresponding to the allotted spaces are printed on the sheet 110.

That is, on the sheet 110, the marks arranged in each of the plural demarcated areas according to a predetermined arrangement rule are printed in a predetermined color (for example, sky blue), and an entry position on the sheet 110 can be specified based on the combination of the marks.

The spaces allotted to the individual telephone number entry boxes a1-a10 are predetermined spaces at different positions in the whole space possible to be given the position information.

The relation between the individual telephone number entry boxes a1-a10 and the spaces allotted thereto is decided uniquely for each customer code which is an example of definition information for each of the sheets 110.

For example, if the numbers of the 10 spaces allotted to the individual telephone number entry boxes a1-a10 are “1” to “10”, the arrangement of the numbers of the spaces allotted to the entry boxes a1-a10 in order from left to right (in order of the entry) is changed as follows, depending on the customer code which is the definition information for each of the sheet 110.
“1, 2, 3, 4, 5, 6, 7, 8, 9, 10” for the customer code (0000001)
“1, 2, 3, 4, 5, 6, 7, 8, 10, 9” for the customer code (0000002)
“10, 9, 8, 7, 6, 5, 4, 3, 2, 1” for the customer code (3628800)

In this manner, a large number of customer codes can be expressed.

Incidentally, the dot patterns may be printed not only on the areas surrounded by the entry boxes a1-a19 but also on the whole front face of the sheet 110.

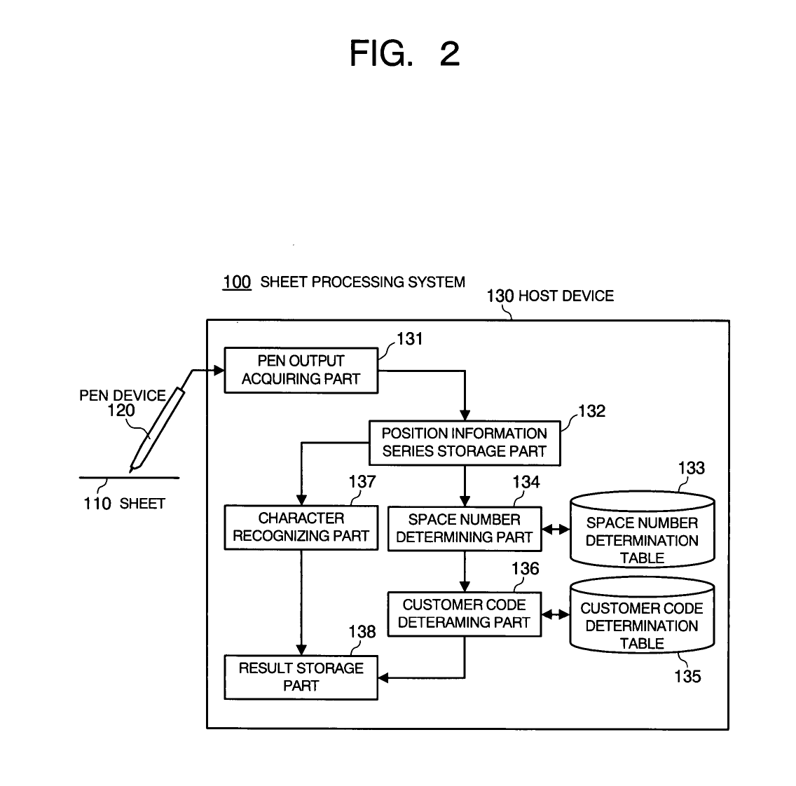

FIG. 2 is a block diagram showing the whole configuration of the sheet processing system 100 processing the sheet 110 having the format shown in FIG. 1.

As shown in FIG. 2, the sheet processing system 100 is composed of a pen device 120 used for writing on the sheet 110 and a host device 130 processing an output of the pen device 120.

First, the structure and operation of the pen device 120 will be described.

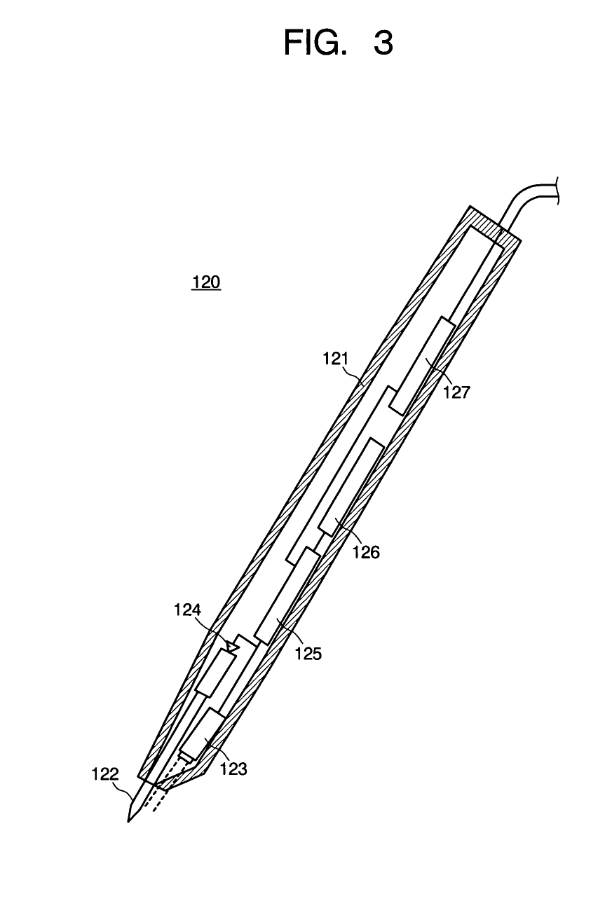

FIG. 3 is a view showing the structure of the pen device 120 used in the sheet processing system 100.

As shown in FIG. 3, the pen device 120 includes a casing 121 having a shape that can be easily gripped by a user.

A pen portion 122 capable of actually writing on a front face of the sheet 110 with ink is provided at one end of the casing 121.

Further, in the casing 121, provided is a camera 123 including an image sensor such as CCD (Charge-Coupled Devices), a CMOS (Complementary Metal-Oxide Semiconductor) sensor, or the like to capture an image of an area, in the front face of the sheet 110, including a position on which a tip of the pen portion 122 abuts and the vicinity of this position.

In the casing 121, a pressure sensor 124 detecting a write pressure of the pen portion 122 is provided so that the timing of the writing on the sheet 110 by the pen portion 122 is known.

A control part 125, a memory 126, a communication part 127, and so on are further provided in the casing 121.

The control part 125 performs central control over the respective parts in the pen device 120 and processing of video data acquired by the camera 123, for example, processing for extracting the aforesaid dot pattern from the video data and converting the extracted dot pattern to the position information.

The memory 126 is used as an area for temporarily storing the video data acquired by the camera 123, a work area for the control part 125 to process the video data, and the like.

Further, the memory 126 stores programs necessary for the control part 125 to process the video data, a conversion table referred to when the dot pattern is converted to the position data, and so on.

The communication part 127 processes communication with the host device 130 by USB (Universal Serial Bus), radio, or the like.

Next, the operation of the pen device 120 will be described.

The camera 123 captures an image of an area, in the front face of the sheet 110, including the position on which the tip of the pen portion 122 abuts and the vicinity of this position.

The control part 125 monitors a change in an output of the pressure sensor 124.

The control part 125 determines that the output of the pressure sensor 124 has reached a predetermined threshold value when the pen portion 122 abuts on the front face of the sheet 110 and loads the video data captured by the camera 123 into the memory 126.

Next, the control part 125 extracts the dot pattern from the video data stored in the memory 126 and determines the position information corresponding to the dot pattern by using the conversion table stored in the memory 126.

Incidentally, the dot pattern mentioned here is a pattern which is the position information coded according to the combination of deviation directions of the individual dots from the respective reference positions.

The position information is generated at predetermined time intervals, and consequently, a series of the position information corresponding to trajectories (strokes) made by the pen portion 122 of the pen device 120 moving on the front face of the sheet 110 is obtained.

The series of the position information thus obtained is transferred to the host device 130 by the communication part 127.

For example, when the telephone number is entered with the pen device 120 in the telephone number entry boxes a1-a10 of the sheet 110, the dot patterns at the entry positions are read by the camera 123.

The control part 125 decodes the position information corresponding to the dot pattern with reference to the conversion table stored in the memory 126 and transmits the resultant to the host device 130 via the communication part 127.

The position information is made up of values of the XY coordinates and time data.

Next, the structure of the host device 130 will be described.

The host device 130 is a device including, as hardware, components such as a CPU (Central Processing Unit), a memory, a storage device, an input device, an output device, and the like that a typical computer has.

For example, a PC (Personal Computer) or the like is used as the host device 130.

The storage device or the memory stores programs, various tables, and so on necessary for the sheet processing executed by the CPU.

As shown in FIG. 2, the host device 130 includes a pen output acquiring part 131, a position information series storage part 132, a space number determination table 133 as a first storage part, a space number determining part 134 as a first determining part, a customer code determination table 135 as a second storage part, a customer code determining part 136 as a second determining part, a character recognizing part 137, and a result storage part 138 as a third storage part.

The pen output acquiring part 131 acquires the series of the position information which is outputted by the pen device 120 when the sheet 110 is filled in by the pen device 120.

The position information series storage part 132 is a storage part storing the series of the position information acquired by the pen output acquiring part 131 from the pen device 120.

The position information series storage part 132 stores position information inputted at predetermined time intervals from the pen device 120.

Here, the position information is information indicating a position in the whole space possible to be given the position information by the aforesaid dot patterns.

Further, each of the position information acquired from the pen device 120 is appended with time data indicating the time at which the dot pattern is decoded to the position information by the pen device 120.

The space number determination table 133 is a table storing in advance information necessary for identifying the spaces allotted to the respective telephone number entry boxes a1-a10 set in the sheet 110.

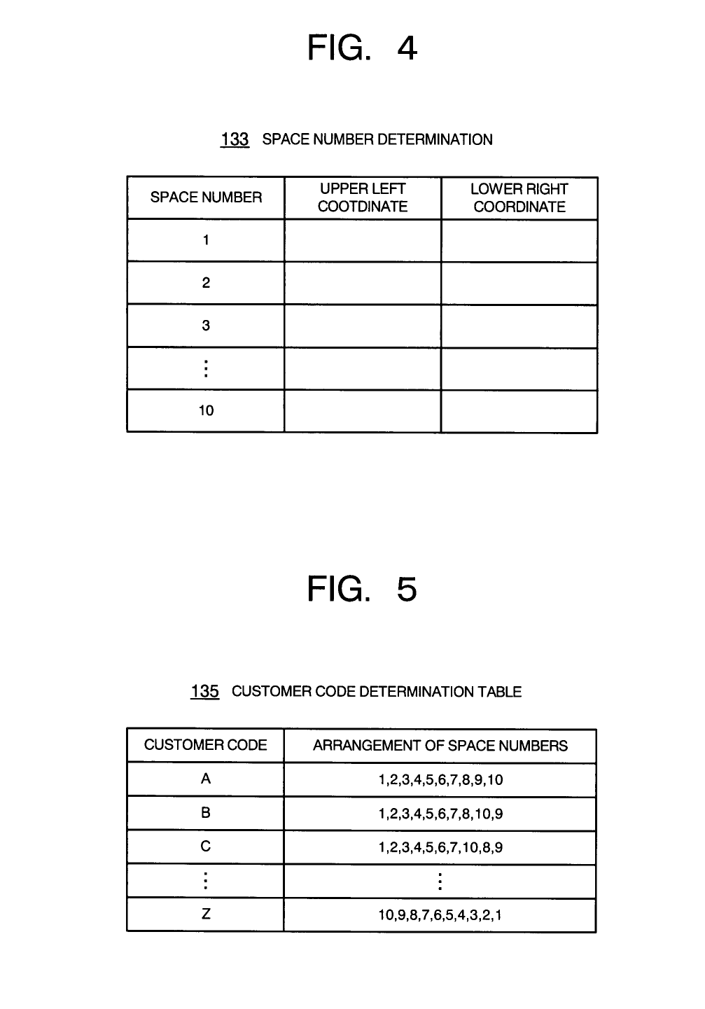

FIG. 4 is a view showing an example of the space number determination table 133.

As shown in FIG. 4, in the space number determination table 133, the numbers from “1” to “10” being identification information of the individual spaces which are decided in advance to be allotted to the telephone number entry boxes a1-a10 are registered in correspondence to upper left and lower right coordinate values representing information on positions of the spaces.

Here, the information on the position of the space is information indicating a position in the whole space possible to be given the position information by the aforesaid dot pattern.

The space number determining part 134 compares the series of the position information stored in the position information series storage part 132 and the information on the positions of the spaces registered in the space number determination table 133.

By this comparison, the space number determining part 134 determines which one of the spaces registered in the space number determination table 133 each of the position information acquired from the pen device 120 belongs to, and in order of the entry, it determines the space numbers corresponding to the determined spaces, out of the space numbers registered in the space number determination table 133, thereby generating an arrangement of the space numbers.

The customer code determination table 135 is a table in which arrangements of the space numbers and customer codes, which are definition information, corresponding to the respective arrangements are registered in advance. FIG. 5 is a view showing an example of the customer code determination table 135.

The customer code determining part 136 compares the arrangement of the space numbers generated by the space number determining part 134 and the arrangements of the space numbers registered in the customer code determination table 135 and determines the customer code, which is the definition information, corresponding to the matching arrangement of the space numbers, out of the arrangements of the space numbers registered in the customer code determination table 135.

The character recognizing part 137 performs character recognition by comparing the series of the position information for one character stored in the position information series storage part 132 and a dictionary storing standard patterns of characters to obtain a character code as a result of the character recognition.

For example, the character recognizing part 137 recognizes characters which are entered with the pen device 120 in the telephone number entry boxes a1-a10 provided in the sheet 110.

The character recognizing part 137 assembles 10 character codes obtained as a result of the recognition into one character code string to generate data on the telephone number.

Further, the character recognizing part 137 recognizes characters entered with the pen device 120 in the entry boxes a11-a19 provided in the sheet 110 for the entry of a purchase quantity of each kind of item, and from the resultant character code string, it generates data on the purchase quantity of each kind of item.

The result storage part 138 is a storage part storing the combination of the customer code determined by the customer code determining part 136 and the data on the telephone number and the purchase quantity of each kind of item obtained by the character recognizing part 137.

That is, the result storage part 138 stores the character recognition results and the customer code determination result.

Next, the operation of the sheet processing system 100 of this embodiment will be described.

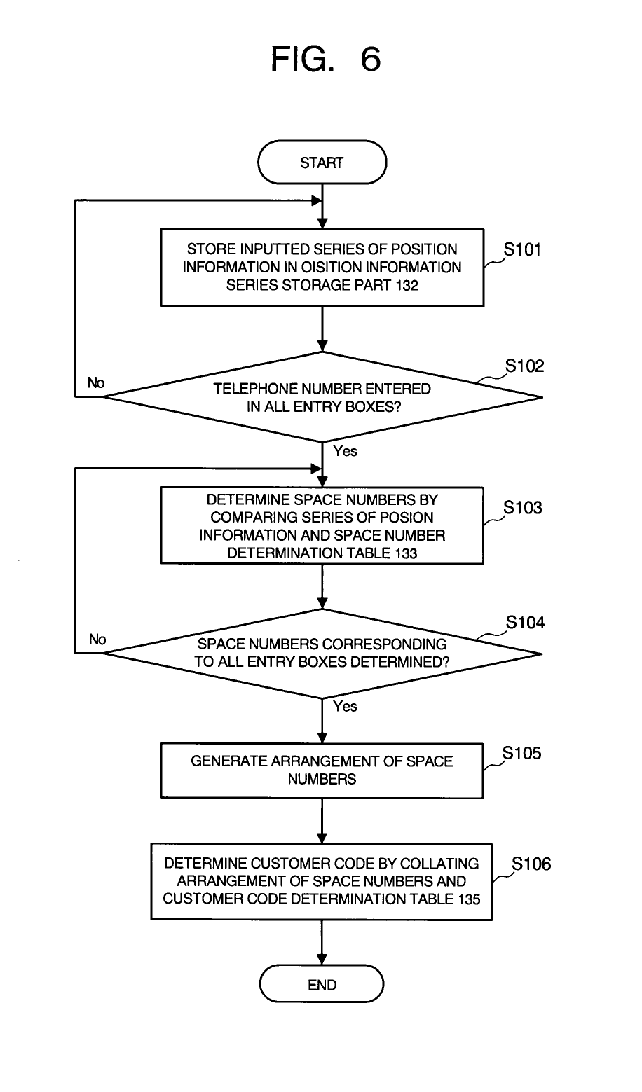

FIG. 6 is a flowchart showing the operation from the output of the pen device 120 and the determination of the customer code in the sheet processing system 100.

While characters are entered with the pen device 120 in the telephone number entry boxes a1-a10 set in the sheet 110, the host device 130 stores in the position information series storage part 132 the series of the position information acquired from the pen device 120 by the pen output acquiring part 131 (Step S101).

Next, based on the series of the position information stored in the position information series storage part 132, the space number determining part 134 of the host device 130 determines whether or not the entry in all the telephone number entry boxes a1-a10 set in the sheet 110 has been completed (Step S102).

After the completion of the entry of a character in one of the telephone number entry boxes, there occurs a relatively long input waiting time before the entry of a character in the next entry box is started.

Therefore, based on the time data in the position information stored in the position information series storage part 132, the space number determining part 134 finds the timing at which the pen tip moves between the two entry boxes and then recognizes the series of the position information for each character.

Then, the space number determining part 134 goes to the next process when determining that the entry in all the telephone number entry boxes a1-a10 set in the sheet 110 has been completed (YES at Step S102).

That is, the space number determining part 134 starts the next process when confirming the entry in all the telephone number entry boxes.

The space number determining part 134 compares the series of the position information for each character stored in the position information series storage part 132 and the information on the positions of the spaces registered in the space number determination table 133 to determine which space the position information acquired from the pen device 120 belongs to, and determines the space number corresponding to the determined space, out of the space numbers registered in the space number determination table 133 (Step S103).

The space number determining part 134 repeats this process for the series of all the position information stored in the position information series storage part 132 (Step S104), and when the space numbers of all the entry boxes are determined (YES at Step S104), it generates the arrangement of the space numbers (Step S105).

The generated arrangement of the space numbers is passed to the customer code determining part 136.

The customer code determining part 136 compares the arrangement of the space numbers passed from the space number determining part 134 and the arrangements of the space numbers registered in the customer code determination table 135 to determine the customer code (Step S106).

That is, since the arrangements of the ten space numbers are registered in advance in correspondence to the customer codes in the customer code determination table 135, the customer code determining part 136 compares the arrangement of the space numbers obtained from the space number determining part 134 and the arrangements of the space numbers registered in the customer code determination table 135 to determine the customer code corresponding to the matching arrangement of the space numbers.

Then, the customer code determining part 136 stores the determined customer code in the result storage part 138.

Meanwhile, the character recognizing part 137 performs the character recognition by comparing the series of the position information for one character stored in the position information series storage part 132 and the dictionary storing the standard patterns of characters, thereby obtaining a character code as the character recognition result.

The character recognizing part 137 repeats this character recognition process every time the series of the position information for one character is stored in the position information series storage part 132 to generate data on the telephone number and data on the purchase quantity of each kind of item, and stores these data in the result storage part 138 in correspondence to the customer code determined by the customer code determining part 136.

As described above, according to the sheet processing system 100 of this embodiment, following the operation of the entry of the telephone number in the sheet 110 with the pen device 120, it is possible to determine the customer code which is the definition information for each of the sheets 110.

Further, according to the sheet processing system 100 of this embodiment, only by consuming the spaces corresponding to the telephone number entry boxes a1-a10, it is possible to define a large number of customer codes, which can enhance use efficiency of the dot patterns.

In the above-described embodiment, the relation between the telephone number entry boxes a1-a10 and the spaces allotted thereto can be changed depending on the definition information for each of the sheets 110, but the relation of entry boxes for the entry of information other than the telephone number and spaces allotted thereto may be changed.

### Second Embodiment

Next, a second embodiment of the present invention will be described.

First, a typical sheet compared with a sheet adopted in this embodiment will be described.

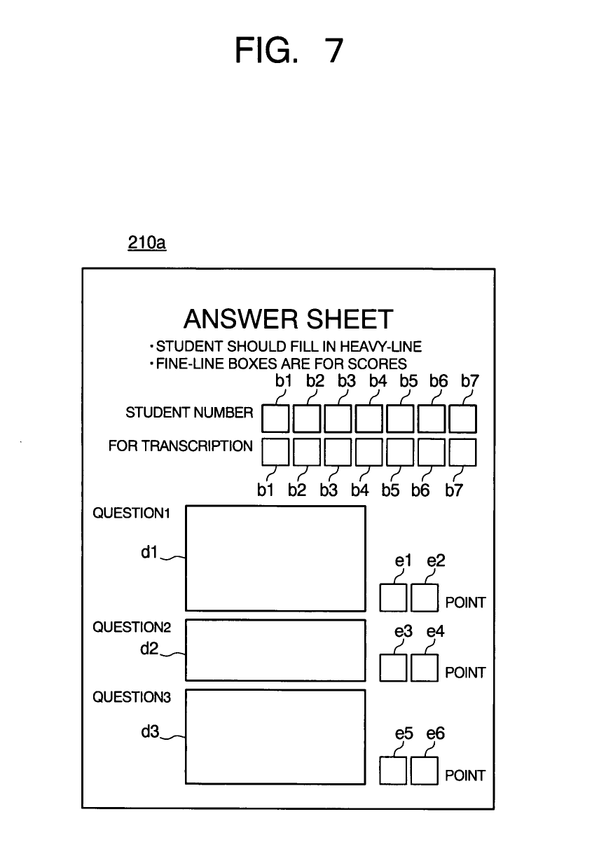

FIG. 7 is a view showing a format of a test answer sheet (sheet 210a) as a typical sheet.

In this typical sheet 210a, provided are entry boxes b1-b7 in which a test taker enters his/her six-figure student number, answer columns d1-d3 in which the test taker enters answers to test questions, entry boxes c1-c7 in which a marker transcribes the student number entered in the entry boxes b1-b7, and entry boxes e1-e6 in which the marker enters scores for the answer columns d1-d3.

In each of areas surrounded by the transcription entry boxes c1-c7 and the score entry boxes e1-e6, a dot pattern similar to that of the sheet 110 of the first embodiment is printed.

Incidentally, the dot pattern may be printed not only on each of the areas surrounded by the transcription entry boxes c1-c7 and the score entry boxes e1-e6 but also on the whole front face of the sheet 110.

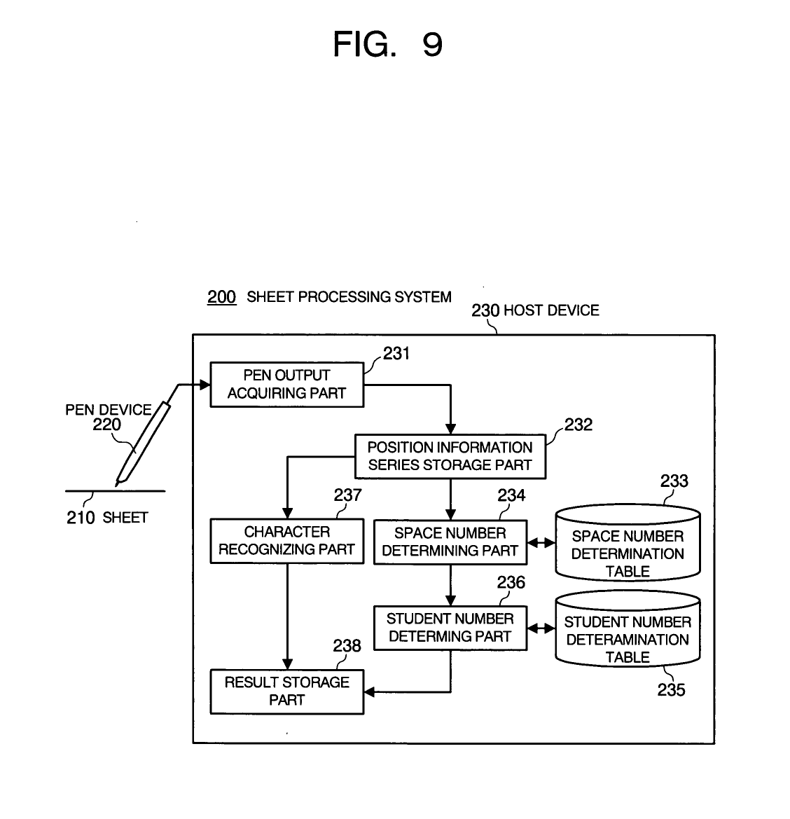

The test taker uses an ordinary pen when entering the student number and answer phrases in the student number entry boxes b1-b7 and the answer columns d1-d3, and the marker uses a pen device 220 (see FIG. 9) when entering the transcription of the student number and the scores in the transcription entry boxes c1-c7 and the score entry boxes e1-e6.

Among the score entry boxes e1-e6, the tens digits of the scores are entered in the boxes e1, e3, e5, and the ones digits of the scores are entered in the boxes e2, e4, e6.

When the student number is transcribed in the transcription entry boxes c1-c7 of the typical sheet 210a with the pen device 220, a host device 230 (see FIG. 9) recognizes the numerals entered in the transcription entry boxes c1-c7 based on a series of position information acquired from the pen device 220 and obtains the arrangement of the numerals entered in all the transcription entry boxes c1-c7 as data on the student number.

Further, when the scores are entered in the score entry boxes e1-e6 with the pen device 220, the host device 230 obtains data on the scores by recognizing the numerals entered in the score entry boxes e1-e6 based on a series of position information acquired from the pen device 220.

As described above, in an input operation to the typical sheet 210a with the pen device 220, the student number entered in the student number entry boxes b1-b7 on the sheet 210a has to be transcribed to the transcription entry boxes c1-c7 by the marker by using the pen device 220, which is a burden to the marker.

Applying the present invention frees the marker from the need for such transcription of the student number, which can improve work efficiency of the marker.

Hereinafter, a sheet processing system (see FIG. 9) of the second embodiment will be described.

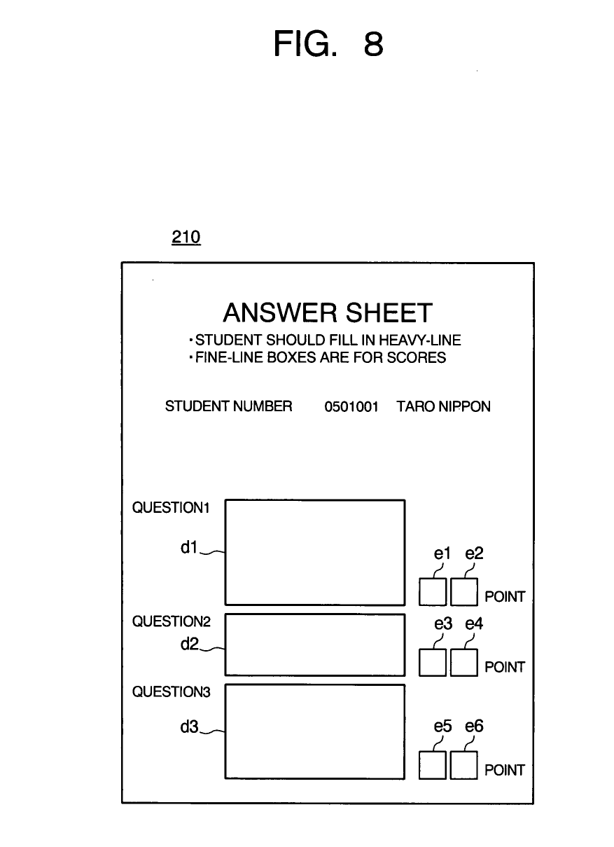

FIG. 8 is a view showing an example of a format of a test answer sheet as a sheet 210 adopted in the sheet processing system of the second embodiment.

As shown in FIG. 8, in the sheet 210, provided are answer columns d1-d3 in which a test taker enters answers by using an ordinary pen, and entry boxes e1-e6 in which a marker enters scores corresponding to the answer columns d1-d3 by using the pen device 220.

That is, in the format of the sheet 210 of this embodiment, the student number entry boxes b1-b7 and the student number transcription entry boxes c1-c7 which are provided in the format of the typical sheet 210a shown in FIG. 7 are not provided.

Here, spaces allotted to the individual score entry boxes e1-e6 are predetermined spaces at different positions in a whole space possible to be given position information.

The relation between the individual score entry boxes e1-e6 and the spaces allotted thereto is decided depending on each student number which is an example of definition information for each of the sheets 210.

For example, if the numbers of the six spaces allotted to the score entry boxes e1-e6 are “1” to “6”, the arrangement of the numbers of the spaces allotted to the entry boxes e1-e6 in order from left to right (in order of entry) is changed as follows depending on the student number which is the definition information.
“1, 2, 3, 4, 5, 6” for the student number (001)
“1, 2, 3, 4, 6, 5” for the student number (002)
“6, 5, 4, 3, 2, 1” for the student number (720).
   With these arrangements, a large number of student numbers can be expressed.

Incidentally, the dot patterns may be printed not only on areas surrounded by the score entry boxes e1-e6 but also on the whole front face of the sheet 210.

FIG. 9 is a block diagram showing the whole configuration of a sheet processing system 200 processing the sheet 210 having the format shown in FIG. 8.

As shown in FIG. 9, the sheet processing system 200 is composed of the pen device 220 used for writing on the sheet 210 and the host device 230 processing an output of the pen device 220.

The structure and operation of the pen device 220 are the same as those of the pen device 120 of the first embodiment, and therefore description thereof will be omitted.

The host device 230 includes a pen output acquiring part 231, a position information series storage part 232, a space number determination table 233, a space number determining part 234, a student number determination table 235, a student number determining part 236, a character recognizing part 237, and a result storage part 238.

The pen output acquiring part 231 acquires a series of position information which is outputted from the pen device 220 when the sheet 210 is filled in by the pen device 220.

The position information series storage part 232 is a storage part storing the series of the position information acquired from the pen device 220 by the pen output acquiring part 231.

The position information series storage part 232 stores position information inputted at predetermined time intervals from the pen device 220.

Here, the position information is information indicating a position in the whole space possible to be given the position information by the aforesaid dot pattern.

Further, the individual position information acquired from the pen device 220 is appended with time data indicating the time at which the dot pattern is decoded to the position information by the pen device 220.

The space number determination table 233 is a table storing in advance information necessary for determining the spaces allotted to the score entry boxes e1-e6 set in the sheet 210.

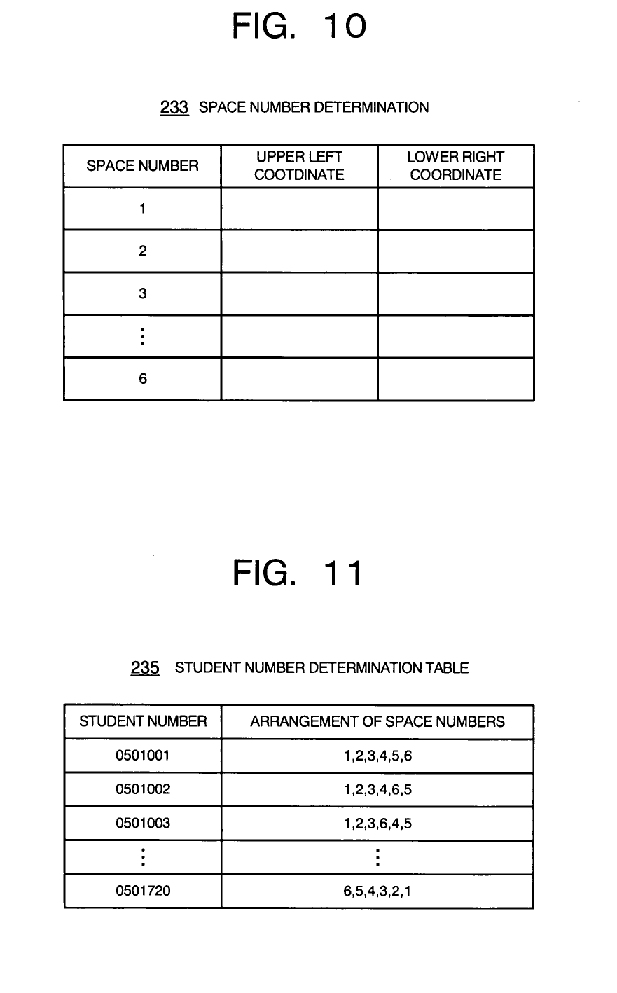

FIG. 10 is a view showing an example of the space number determination table 233. As shown in FIG. 10, in the space number determination table 233, the numbers from “1” to “6” of the individual spaces which are decided in advance to be allotted to the score entry boxes e1-e6 are registered in correspondence to upper left and lower right coordinate values representing information on positions of the spaces.

Here, the information on the position of the space is information indicating a position in the whole space possible to be given the position information by the aforesaid dot pattern.

The space number determining part 234 compares the series of the position information stored in the position information series storage part 232 and the information on the positions of the spaces registered in the space number determination table 233 to determine which of the spaces registered in the space number determination table 233 each of the position information acquired from the pen device 220 belongs to, and in order of the entry, it determines the space numbers corresponding to the determined spaces, out of the space numbers registered in the space number determination table 233, thereby generating the arrangement of the space numbers.

The student number determination table 235 is a table in which the arrangements of the space numbers and the student numbers corresponding to the respective arrangements are registered in advance.

FIG. 11 is a view showing an example of the student number determination table 235. The student number determining part 236 compares the arrangement of the space numbers generated by the space number determining part 234 and the arrangements of the space numbers registered in the student number determination table 235 and determines the student number, which is definition information, corresponding to the matching arrangement of the space numbers, out of the arrangements of the space numbers registered in the student number determination table 235.

The character recognizing part 237 performs character recognition by comparing the series of the position information for one character stored in the position information series storage part 232 and a dictionary storing standard patterns of characters, thereby obtaining a character code as the result of the character recognition.

For example, the character recognizing part 237 recognizes each of characters entered with the pen device 220 in the score entry boxes e1-e6 provided in the sheet 210 and determines score data based on the character code obtained as a result of the recognition.

The result storage part 238 is a storage part storing the combination of the student number determined by the student number determining part 236 and the score data obtained by the character recognizing part 237.

That is, the result storage part 238 stores the character recognition results and the student number determination result.

Next, the operation of the sheet processing system 200 of this embodiment will be described.

A marker first enters scores in the score entry boxes e1, e2 corresponding to the answer column d1 for the first question on the sheet 210 by using the pen device 220.

At this time, since it is necessary to enter the two-figure score in the entry boxes e1, e2, the marker needs to enter “0” in the entry box e1 for the tens digit when the score is below 10 points.

Next, the operation of the sheet processing system 200 of this embodiment will be described.

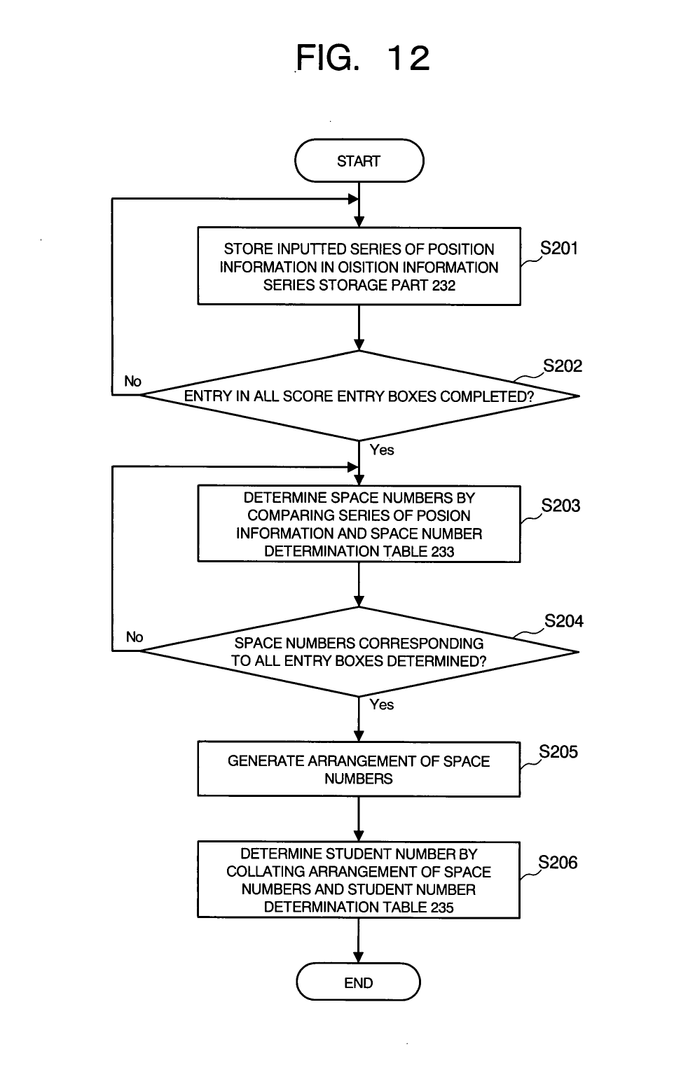

FIG. 12 is a flowchart showing the operation from the output of the pen device 220 to the determination of the student number in the sheet processing system 200.

While scores are entered with the pen device 220 in the score entry boxes e1-e6 set in the sheet 210, the pen output acquiring part 231 of the host device 230 stores the series of the position information acquired from the pen device 220 in the position information series storage part 232 (Step S201).

Next, based on the series of the position information stored in the position information series storage part 232, the space number determining part 234 of the host device 230 determines whether or not the entry in all the score entry boxes e1-e6 set in the sheet 210 has been completed (Step S202).

Then, the flow goes to the next process when the host device 230 determines that the entry in all the score entry boxes e1-e6 set in the sheet 210 has been completed (YES at Step S202).

That is, the host device 230 causes the space number determining part 234 to start the next process when the entry in all the score entry boxes are confirmed.

The space number determining part 234 compares the series of the position information for each character stored in the position information series storage part 232 and the information on the positions of the spaces registered in the space number determination table 233 to determine which space the position information acquired from the pen device 220 belongs to.

Then, the space number determining part 234 determines the space number corresponding to the determined space, out of the space numbers registered in the space number determination table 233 (Step S203).

The space number determining part 234 repeats this process for the series of all the position information stored in the position information series storage part 232 (Step S204), and when the space numbers of all the entry boxes are determined (YES at Step S204), it generates the arrangement of the space numbers (Step S205).

The generated arrangement of the space numbers is passed to the student number determining part 236.

The student number determining part 236 compares the arrangement of the space numbers passed from the space number determining part 234 and the arrangements of the space numbers registered in the student number determination table 235 to determine the student number (Step S206).

That is, since the arrangements of the six space numbers are registered in advance in correspondence to the student numbers, the student number determining part 236 compares the arrangement of the six space numbers obtained from the space number determining part 234 and the arrangements of the space numbers registered in the student number determination table 235 to determine the student number corresponding to the matching arrangement of the space numbers.

Then, the student number determining part 236 stores the determined student number in the result storage part 238.

Meanwhile, the character recognizing part 237 performs the character recognition by comparing the series of the position information for one character stored in the position information series storage part 232 and the dictionary storing the standard patterns of characters, thereby obtaining a character code as the character recognition result.

The character recognizing part 237 repeats this character recognition process every time the series of the position information for one character is stored in the position information series storage part 232 to generate score data corresponding to the three answer columns d1-d3 and generates the total of the three score data.

Thus obtained score data are stored in the result storage part 238 in correspondence to the data on the student number obtained by the student number determining part 236.

As described above, according to the sheet processing system 200 of this embodiment, following the operation of entering the scores in the sheet 210 with the pen device 220, it is possible to determine the data on the student number which is the definition information for each of the sheets 210.

Consequently, it is possible to obtain the data on the student number, without a marker's trouble of transcribing the student number on the front face of the sheet 210.

Further, according to the sheet processing system 200 of this embodiment, only by consuming the spaces corresponding to the score entry boxes e1-e6, it is possible to define a large number of student numbers, which can enhance use efficiency of the dot patterns.

### Third Embodiment

Next, a third embodiment of the present invention will be described.

In the above-described embodiments, when characters are entered in the entry boxes provided in the sheet, the space numbers corresponding to the entry boxes in which the characters are entered are obtained, and the customer code or the student number corresponding to the arrangement of the space numbers is obtained, but what are entered in the entry boxes are not limited to characters, providing that the space numbers can be obtained.

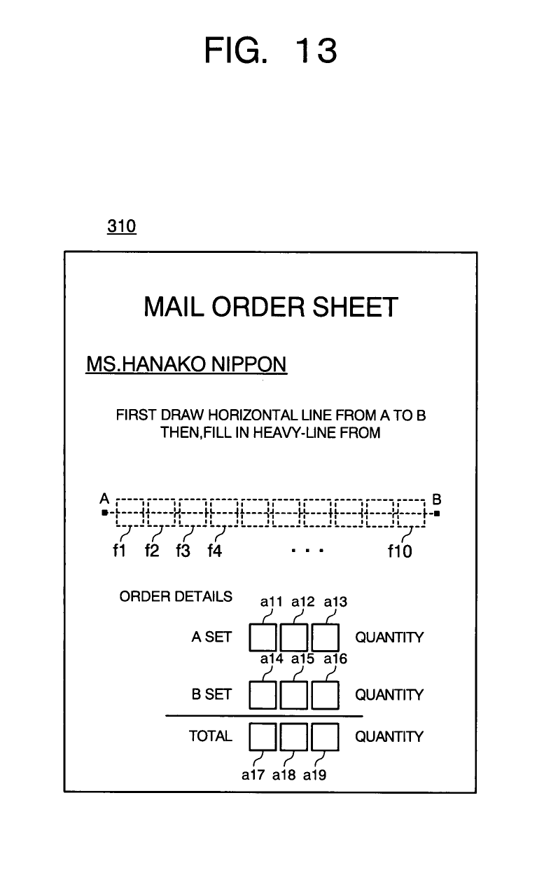

FIG. 13 is an example of a mail order sheet as a sheet 310 in which a line is drawn in specific areas with a pen device, thereby making it possible to obtain the numbers of spaces in which the line is drawn.

In the sheet 310, ten areas f1-f10 for line entry are arranged in a row.

In each of the areas f1-f10, a dot pattern is printed as in the sheet 110 of the first embodiment.

Here, spaces allotted to the individual areas f1-f10 are predetermined spaces at different positions in a whole space possible to be given position information.

The relation between the individual areas f1-f10 and the spaces allotted thereto is decided depending on each customer code as an example of definition information for each of the sheets 310.

In the sheet 310, a line is drawn from A point to B point in FIG. 13 with a pen device so as to pass the ten areas f1-f10.

The areas f1-f10 are visualized by the lines surrounding them but may be invisible.

Further, in the sheet 310, entry boxes a11-a19 for the entry of a purchase quantity of each kind of item are provided, and the aforesaid dot pattern is printed also on each of the areas surrounded by the entry boxes a1-a19.

Incidentally, the dot patterns may be printed not only on the individual areas surrounded by the line entry areas f1-f10 and the entry boxes a11-a19 for the entry of the purchase quantity but on the whole front face of the sheet 310.

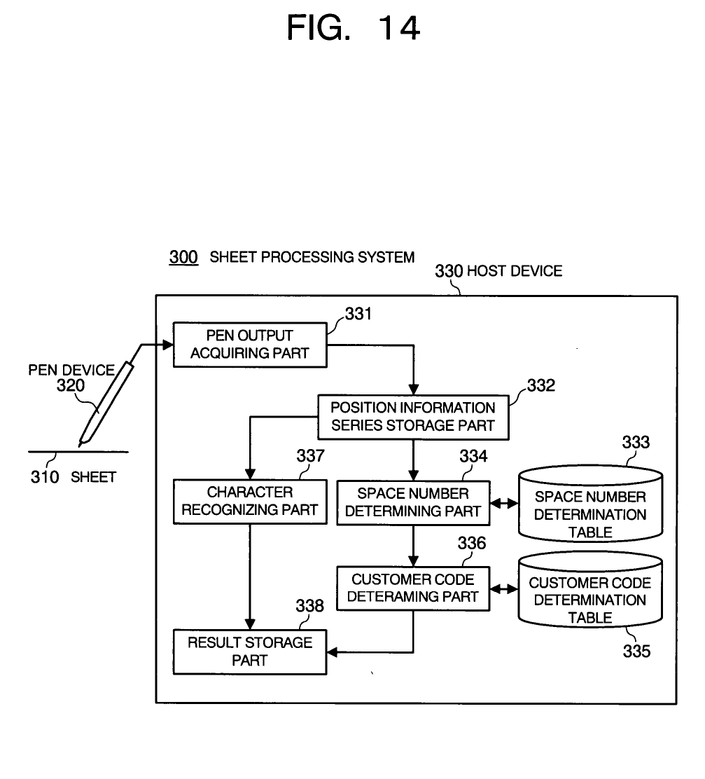

FIG. 14 is a block diagram showing the whole configuration of a sheet processing system 300 processing the sheet 310 in FIG. 13.

As shown in FIG. 14, the sheet processing system 300 of this embodiment is composed of a pen device 320 used for writing on the sheet 310 and a host device 330 processing an output of the pen device 320.

The structure of the pen device 320 is the same as that of the pen device 120 of the first embodiment, and therefore description thereof will be omitted.

The host device 330 includes a pen output acquiring part 331, a position information series storage part 332, a space number determination table 333, a space number determining part 334, a customer code determination table 335, a customer code determining part 336, a character recognizing part 337, and a result storage part 338.

The pen output acquiring part 331 acquires a series of position information which is outputted from the pen device 320 when the sheet 310 is filled in by the pen device 320.

The position information series storage part 332 is a storage part storing the series of the position information acquired from the pen device 320 by the pen output acquiring part 331.

The position information series storage part 332 stores position information inputted at predetermined time intervals from the pen device 320.

Here, the position information is information indicating a position in the whole space possible to be given the position information by the aforesaid dot patterns.

Further, the individual position information acquired from the pen device 320 is appended with time data indicating the time at which the dot pattern is decoded to the position information by the pen device 320.

The space number determination table 333 is a table storing in advance information necessary for determining spaces allotted to the line entry areas f1-f10 set in the sheet 310.

In the space number determination table 333, the numbers from “1” to “10” as identification information of the individual spaces which are decided in advance to be allotted to the line entry areas f1-f10 are registered in correspondence to upper left and lower right coordinate values representing information on positions of the spaces, as shown in FIG. 4.

Here, the information on the position of the space is information indicating a position in the whole space possible to be given the position information by the aforesaid dot pattern.

The space number determining part 334 compares the series of the position information stored in the position information series storage part 332 and the information on the positions of the spaces registered in the space number determination table 333 to determine which one of the spaces registered in the space number determination table 333 each of the position information acquired from the pen device 320 belongs to, and in order of entry, it determines the space numbers corresponding to the determined spaces, out of the space numbers registered in the space number determination table 333, thereby generating an arrangement of the space numbers.

The customer code determination table 335 is a table in which arrangements of the space numbers and the customer codes, which are definition information, corresponding to the respective arrangements are registered in advance, as shown in FIG. 5.

The customer code determining part 336 compares the arrangement of the space numbers generated by the space number determining part 334 and the arrangements of the space numbers registered in the customer code determination table 335 and determines the customer code, which is the definition information, corresponding to the matching arrangement of the space numbers, out of the arrangements of the space numbers registered in the customer code determination table 335.

The character recognizing part 337 performs character recognition by comparing a series of position information for one character stored in the position information series storage part 332 and a dictionary storing standard patterns of characters, thereby obtaining a character code as the result of the character recognition.

For example, the character recognizing part 337 recognizes characters which are entered with the pen device 320 in the entry boxes a11-a19 for the entry of a purchase quantity of each kind of item, provided in the sheet 310.

Then, the character recognizing part 337 obtains data on the purchase quantity of each kind of item based on a character code string thus obtained.

The entry in the line entry areas f1-f10 is not subjected to character recognition.

The result storage part 338 is a storage part storing the combination of the customer code determined by the customer code determining part 336 and the data on the purchase quantity of each kind of item obtained by the character recognizing part 337.

That is, the result storage part 338 stores the character recognition results and the customer code determination result.

Next, the operation of the sheet processing system 300 of this embodiment will be described.

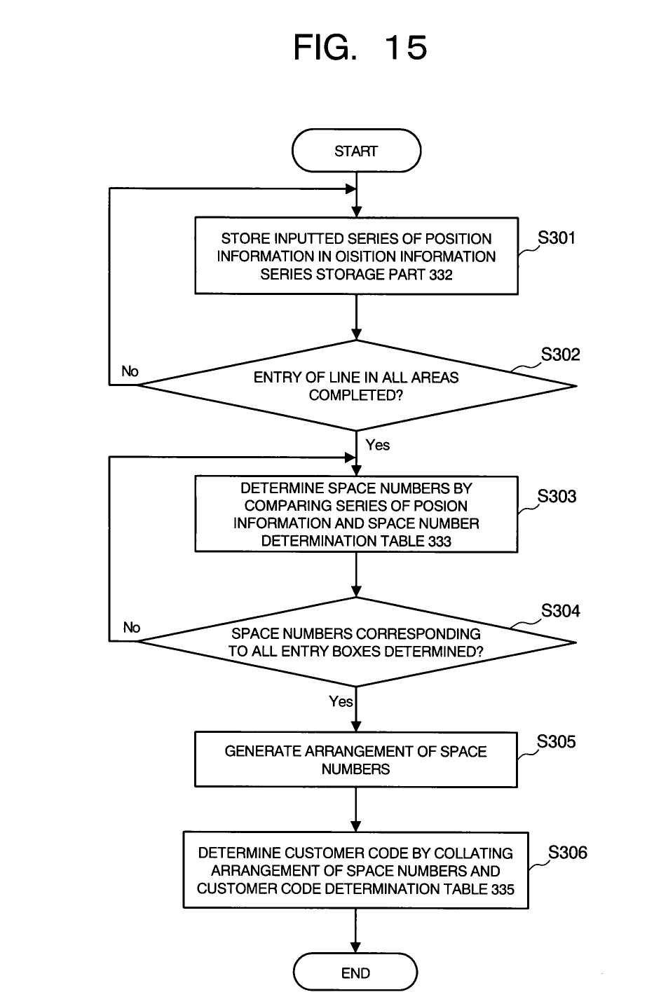

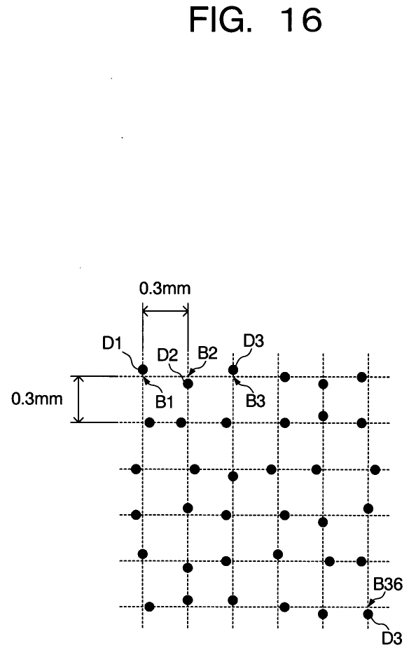

FIG. 15 is a flowchart showing the operation from the output of the pen device 320 to the determination of the customer code in the sheet processing system 300.

While the line is drawn with the pen device 320 in the line entry areas f1-f10 set in the sheet 310, the pen output acquiring part 331 of the host device 330 stores the series of the position information acquired from the pen device 320 in the position information series storage part 332 (Step S301).

Next, based on the series of the position information stored in the position information series storage part 332, the space number determining part 334 of the host device 330 determines whether or not the entry in all the line entry areas f1-f10 set in the sheet 310 has been completed (Step S302).

Then, the space number determining part 334 goes to the next process when determining that the entry in all the line entry areas f1-f10 set in the sheet 310 has been completed (YES at Step S302).

Next, the space number determining part 334 starts the process.

The space number determining part 334 compares the series of the position information stored in the position information series storage part 332 and the information on the positions of the spaces registered in the space number determination table 333 to determine which space the position information acquired from the pen device 320 belongs to, and determines the space number corresponding to the determined space, out of the space numbers registered in the space number determination table 333 (Step S303).

The space number determining part 334 repeats this process for the series of all the position information stored in the position information series storage part 332 (Step S304), and generates the arrangement of the numbers of the spaces in which the line is drawn (Step S305). The generated arrangement of the space numbers is passed to the customer code determining part 336.

The customer code determining part 336 compares the arrangement of the space numbers passed from the space number determining part 334 and the arrangements of the space numbers registered in the customer code determination table 335 to determine the customer code (Step S306).

That is, since the arrangements of the ten space numbers are registered in advance in the customer code determination table 335 in correspondence to the customer codes, the customer code determining part 336 compares the arrangement of the space numbers obtained from the space number determining part 334 and the arrangements of the space numbers registered in the customer code determination table 335 to determine the customer code corresponding to the matching arrangement of the space numbers.

Then, the customer code determining part 336 stores the determined customer code in the result storage part 338.

In the entry boxes a11-a19 for the entry of the purchase quantity of each kind of item provided on the sheet 310, numerals are entered with the pen device 320.

Consequently, the character recognizing part 337 performs the character recognition by comparing the series of the position information for one character stored in the position information series storage part 332 and the dictionary storing the standard patterns of characters, thereby obtaining a character code as the character recognition result.

The character recognizing part 337 repeats this character recognition process every time the series of the position information for one character is stored in the position information series storage part 332 to generate data on the purchase quantity of each kind of item.

Then, the character recognizing part 337 stores these data in the result storage part 338 in correspondence to the customer code determined by the customer code determining part 336.

As described above, according to the sheet processing system 300 of this embodiment, following an operation of drawing the line with the pen device 320 in the line entry areas f1-f10 provided in the sheet 310, it is possible to determine the customer code which is the definition information for each of the sheets 310.

Further, according to the sheet processing system 300 of this embodiment, only by consuming the spaces corresponding to the line entry areas f1-f10, it is possible to define a large number of customer codes, which can enhance use efficiency of the dot patterns.

Further, since a large number of customer codes can be expressed with the dot patterns corresponding to a small number of spaces, it is possible to enhance use efficiency of the dot patterns.

### Other Modified Example

In the first embodiment, the allotment of the spaces to all the telephone number entry boxes a1-a10 on the sheet 110 in FIG. 1 is changed depending on the definition information for each sheet, but a space allotted to only one of the entry boxes a1-a10 may be changed.

For example, a space allotted to the entry box a1 is changed depending on each customer, and spaces allotted to the entry boxes a2-a10 are common to customers.

Further, in the above-described embodiments, the information such as the customer code, the student number, or the like is specified based on the arrangement of the numbers of the spaces whose position information are represented by the dot patterns, but any information may be specified, providing that it is information desired to be specified for each sheet.

What is claimed is:

1. A sheet processing system, comprising:
an acquiring part acquiring an output of a pen device used for writing on a sheet on which marks arranged in each of a plurality of demarcated areas according to a predetermined arrangement rule are printed and whose entry position is specifiable by a combination of the marks, and reading values of the plural marks existing at each of entry positions to generate a series of position information;
a first storage part storing identification information of the individual spaces allottable to the plural areas of the sheet and information on positions of the spaces in correspondence to each other;
a first determining part which sequentially determines the identification information of the spaces allotted to the plural areas written on by the pen device, by comparing the series of the position information acquired by said acquiring part and the information on the positions of the individual spaces stored in said first storage part, and generates an arrangement of the identification information of the spaces;
a second storage part storing in advance arrangements of the identification information of the spaces and information corresponding to the arrangements; and
a second determining part which determines the information corresponding to the arrangement of the identification information of the spaces which is found to match the arrangement of the identification information of the spaces generated by said first determining part, as a result of comparing the generated arrangement of the identification information of the spaces and the arrangements of the identification information of the spaces stored in said second storage part.

2. The sheet processing system as set forth in claim 1,
wherein the plural areas provided in the sheet are areas in which characters are entered by the pen device, and the system further comprising:
a character recognition part recognizing the characters entered in the plural areas; and
a third storage part storing the information determined by said second determining part and information on the characters recognized by said character recognizing part in correspondence with each other.

3. A sheet processing method for processing a sheet on which marks arranged in each of a plurality of demarcated areas according to a predetermined arrangement rule are printed and whose entry position is specifiable by a combination of the marks, the method comprising:
preparing a first storage part storing identification information of the individual spaces allottable to the plural areas of the sheet and information on positions of the spaces in correspondence to each other, and a second storage part storing in advance arrangements of the identification information of the spaces and information corresponding to the arrangements;
acquiring an output of a pen device used for writing on the sheet and reading the values of the plural marks existing at each of entry positions to generate a series of the position information;
sequentially determining the identification information of the spaces allotted to the plural areas written on by the pen device, by comparing the acquired series of the position information and the information on the positions of the individual spaces stored in the first storage part, and generating an arrangement of the identification information of the spaces; and
determining the information corresponding to the arrangement of the identification information of the spaces which is found to match the generated arrangement of the identification information of the spaces, as a result of comparing the generated arrangement of the identification information of the spaces and the arrangements of the identification information of the spaces stored in the second storage part.

4. A program realizing in a computer a function of processing a sheet on which marks arranged in each of a plurality of demarcated areas according to a predetermined arrangement rule are printed and whose entry position is specifiable by a combination of the marks, the program causing the computer to function as:
an acquiring part acquiring an output of a pen device used for writing on the sheet and reading the values of the plural marks existing at each of entry positions to generate a series of the position information;
a first storage part storing identification information of the individual spaces allottable to the plural areas of the sheet and information on positions of the spaces in correspondence to each other;
a first determining part which sequentially determines the identification information of the spaces allotted to the plural areas written on by the pen device, by comparing the series of the position information acquired by said acquiring part and the information on the positions of the individual spaces stored in said first storage part, and generates an arrangement of the identification information of the spaces;
a second storage part storing in advance arrangements of the identification information of the spaces and information corresponding to the arrangements; and
a second determining part which determines the information corresponding to the arrangement of the identification information of the spaces which is found to match the arrangement of the identification information of the spaces generated by said first determining part, as a result of comparing the generated arrangement of the identification information of the spaces and the arrangements of the identification information of the spaces stored in said second storage part.

5. An optically read sheet having a plurality of areas to which different partial spaces in a whole space possible to be given position information are allotted respectively, the position information each being made up of a combination of values of a plurality of marks, with each of the values expressed by a position of the mark relative to a reference position, and on which groups of the marks corresponding to the allotted spaces are printed,
wherein information is defined by the relation between the plural areas and the spaces allotted to the areas.
